(19) United States
(12) Patent Application Publication
(10) Pub. No.: US 2024/0001859 A1
(43) Pub. Date: Jan. 4, 2024

(54) ROOF LUGGAGE BRACKET

(71) Applicant: Jiangxi Senmu Technology Co.,Ltd, Shangrao (CN)

(72) Inventor: XIONG YAO, Shangrao (CN)

(21) Appl. No.: 18/365,267

(22) Filed: Aug. 4, 2023

Related U.S. Application Data
(63) Continuation of application No. PCT/CN2022/111375, filed on Aug. 10, 2022.

(30) Foreign Application Priority Data
May 6, 2022 (CN) 202221058113.3

(51) Int. Cl. B60R 9/058

(52) U.S. Cl. CPC B60R 9/058

(57) ABSTRACT

The present disclosure provides a roof luggage bracket including a crossbar, a clamping device installed at both ends of the crossbar and being capably adjusting a distance, and a shell wrapping the clamping device. The clamping device includes a bracket, a clamping mechanism installed on the bracket, and a locking mechanism; the clamping mechanism includes a first clamping plate, a second clamping plate, and a spare third clamping plate that are installed below the bracket. The first clamping plate is provided with multiple gear slots with different heights for the second clamping plate or the third clamping plate being inserted, and a fastener for connecting the first clamping plate and the second clamping plate or connecting the first clamping plate and the third clamping plate is provided between the first clamping plate and the second clamping plate or between the first clamping plate and the third clamping plate.

### CROSS-REFERENCE TO RELATED APPLICATIONS

This application is a continuation of International Application No. PCT/CN2022/111375, filed on Aug. 10, 2022, which claims priority to Chinese Patent Application No. 202221058113.3, filed with the China National Intellectual Property Administration on May 6, 2022, titled “ROOF LUGGAGE BRACKET”, both of which are hereby incorporated by reference in their entireties.

### TECHNICAL FIELD

The present disclosure relates to the field of car accessories technologies, and in particular, to a roof luggage bracket.

### BACKGROUND

The existing cars in the market generally have a side rail on both sides of the roof, and in order to place luggage on the roof, a luggage bracket is needed to be installed on the car. However, the size and shape of the side rail of cars with different models vary greatly, and there is a problem of mismatching size when selecting a luggage bracket.

Thus, a research and development of a roof luggage bracket for solving the problem of mismatching between the luggage bracket and the side rail of the art has become an urgent problem for skilled people in the art.

### SUMMARY

In order to overcome the shortcomings of the prior art, the present disclosure provides a roof luggage bracket with good universality, simple structure, and convenient installation.

The technical solution of the present disclosure is a roof luggage bracket including a crossbar, a clamping device installed at both ends of the crossbar and being capably of adjusting a distance, and a shell wrapping the clamping device, where the clamping device includes a bracket, a clamping mechanism installed on the bracket, and a locking mechanism;

the clamping mechanism includes a first clamping plate, a second clamping plate, and a spare third clamping plate that are installed below the bracket, the first clamping plate is provided with multiple gear slots with different heights for the second clamping plate or the third clamping plate being inserted, a fastener for connecting the first clamping plate and the second clamping plate or connecting the first clamping plate and the third clamping plate is provided between the first clamping plate and the second clamping plate or between first clamping plate and the third clamping plate.

In an embodiment of the present disclosure, a strip hole is provided on the second clamping plate and third clamping plate for installing the fastener.

In an embodiment of the present disclosure, a gasket is respectively provided between the second clamping plate and the fastener and between third clamping plate and the fastener, and a side surface where the gasket contacts with the fastener is a planar surface and the other side surface where the gasket contacts with the fastener is a spherical surface.

In an embodiment of the present disclosure, a lower end of the second clamping plate is provided with a second clamping member, and the second clamping member is provided with a bend towards the first clamping plate.

In an embodiment of the present disclosure, a lower end of the third clamping plate is provided with a third clamping member, and the third clamping member is provided with two bends towards the first clamping plate, and a height dimension of the second clamping member is greater than that of the third clamping member.

In an embodiment of the present disclosure, the locking mechanism includes a first locking member slidably installed on the crossbar, a second locking member installed on the bracket, and a pushing member that is rotatably installed on the bracket and drives the first locking member to move forward and backward, and the first locking member and the second locking member are slide-fit with each other in an inclined surface and are cooperated to clamp the crossbar; the first clamping member and the second clamping member have a first motion that the first clamping member and the second clamping member clamp the crossbar and a second motion that they release the crossbar when the pushing member driving the first locking member to move forward and backward.

In an embodiment of the present disclosure, a cross-sectional area of the first locking member is in a shape of character “ [symbol] ” and a respective groove is provided on both sides of the first locking member to accommodate the second locking member, a lower bottom surface of the groove and a lower bottom surface of the second locking member is a respective slide-fit slope, and an upper surface of the groove and an upper end of the second locking member cooperate together to clamp the crossbar, one end of the pushing member is rotatably installed on the bracket and the other end of the pushing member is thread-connection to the first locking member; the first locking member and the second locking member have a first motion that they cooperate to clamp the crossbar and a second motion that they release the crossbar when the pushing member driving the first locking member to move backward and forward in a straight line.

In an embodiment of the present disclosure, the second locking member is consisted of two folded plates symmetrically arranged on both sides of the first locking member, the folded plates are in a shape of numeral “7” and fixedly installed on the bracket, and an upper surface of the folded plate is exposed above the bracket.

In an embodiment of the present disclosure, a slope at a lower end of the folded plate gradually increases from front to back, and a slope of a lower surface of the groove of the first locking member gradually decreases from front to back.

In an embodiment of the present disclosure, the pushing member is a bolt and is provided with a bolt head and a limit nut that is fixed installed, the bolt head and limit nut are respectively located on both sides of the bracket.

In an embodiment of the present disclosure, the first clamping plate and the bracket are integrally bent and formed; the bracket is provided with a passing groove for the first locking member to slide.

In an embodiment of the present disclosure, the second locking member is welded and fixed on both side walls of the passing groove.

In an embodiment of the present disclosure, the limit nut and the pushing member are fixed by welding.

In an embodiment of the present disclosure, a sliding groove is arranged in a middle of the crossbar along a length direction for the first locking member to slide, and an upper end of the first locking member is hung inside the sliding groove.

In an embodiment of the present disclosure, two ends of the crossbar are provided with an end cover, the end cover is provided with a snap buckle, a lower surface of the crossbar is provided with a positioning groove for installing the snap buckle in an embedded manner.

In an embodiment of the present disclosure, the sliding groove is provided with a graduated scale that is installed in a slide manner, and an end of the graduated scale is provided with a convex block extending downwards from the sliding groove.

In an embodiment of the present disclosure, an upper surface of the crossbar is provided with an installation groove arranged along a length direction, and the installation groove is provided with a rubber strip that is installed in a slide manner and covers the installation groove.

The beneficial effect of the present disclosure is that the technical solution provides a clamping device at both ends of the crossbar, which can be applied to a car with a side rail on the roof. A distance between both ends of the clamping mechanism of the crossbar is firstly determined through the locking mechanism, and then a clamping force of the clamping mechanism is adjusted through a fastener to firmly clamp the side rail on both sides; in additionally, when the pushing member in the locking mechanism drives the first locking block to move towards a center of the crossbar, the first locking member and second locking member release the clamping force on the crossbar, allowing the clamping device to adjust its position on the crossbar. After adjusting the position, and the pushing member drives the first locking block to move towards an end of the crossbar, the first locking member and second locking member increase the clamping force on the crossbar until it is locked. This technical solution also involves providing with a spare third clamping plate that is used in turn with the second clamping plate to correspond to different sizes of side rail on both sides of the roof. When selecting the second clamping plate, the second clamping plate is installed on the first clamping plate in an insertion manner. The gear slots on the first clamping plate are divided into multiple gears in an upper and a lower location, and an installation height of the second clamping plate can be adjusted in different positions. The first clamping plate and the second clamping plate are then fixed and connected through the fastener. An installation manner of the third clamping plate and the second clamping plate is the same. This technical solution has advantages of good universality, simple structure, convenient installation, convenient adjustment, and high operation reliability.

### BRIEF DESCRIPTION OF DRAWINGS

FIG. 1 is a structural schematic diagram of a roof luggage bracket of an embodiment of the present disclosure.

FIG. 2 is a structural schematic diagram of a clamping device of an embodiment of the present disclosure.

FIG. 3 is a structural schematic diagram of a clamping mechanism of an embodiment of the present disclosure.

FIG. 4 is a structural schematic diagram of the clamping device in another angle of an embodiment of the present disclosure.

FIG. 5 is a structural schematic diagram of a first locking member and a pushing member of an embodiment of the present disclosure.

FIG. 6 is a bottom view of a crossbar of an embodiment of the present disclosure.

FIG. 7 is a schematic diagram of a split structure of the roof luggage bracket of an embodiment of the present disclosure.

FIG. 8 is a structural schematic diagram of a fastener and a gasket of an embodiment of the present disclosure.

FIG. 9 is a local structural schematic diagram of the crossbar of an embodiment of the present disclosure.

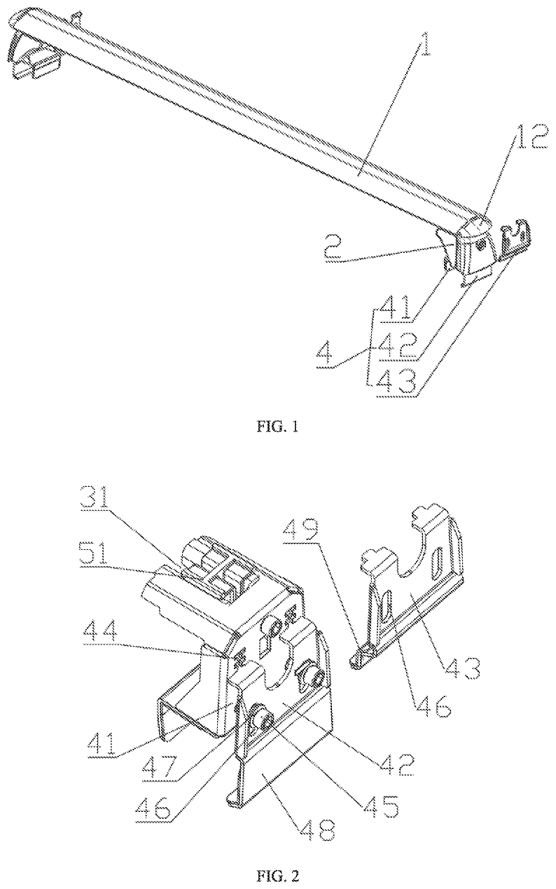

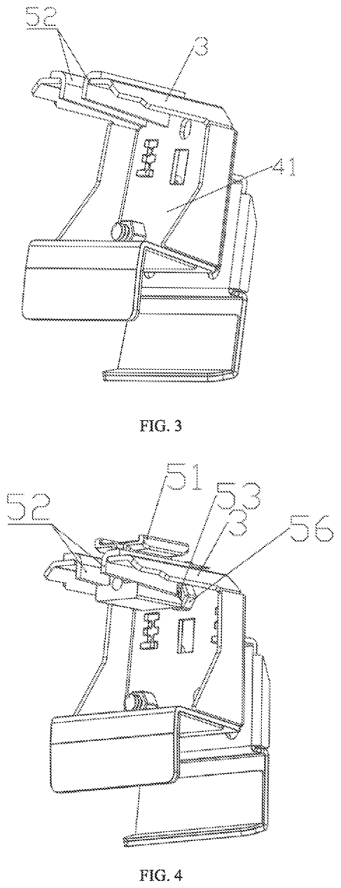

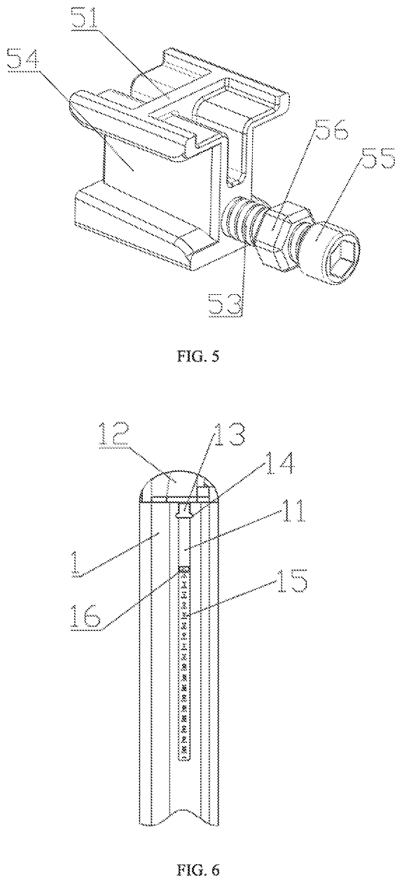

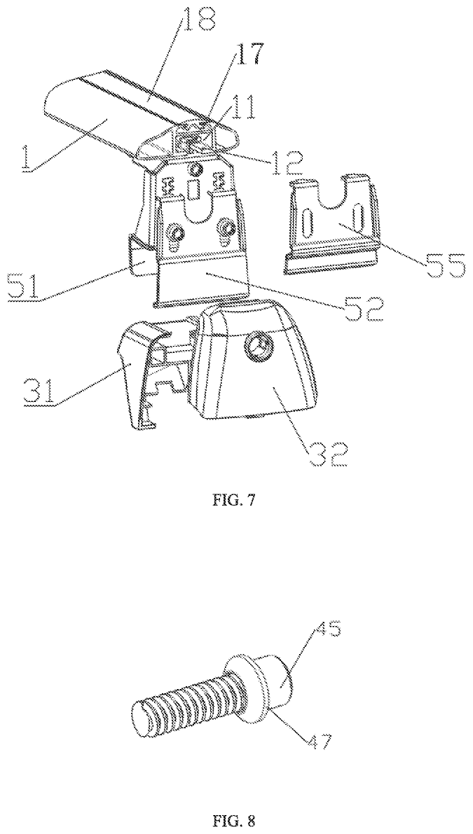

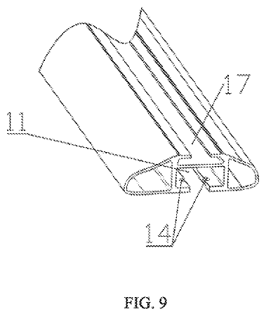

### DESCRIPTION OF EMBODIMENTS

The following is a further explanation of the embodiments of the present disclosure in combination with the drawings.

As shown in the drawings, a roof luggage bracket includes a crossbar 1, a clamping device installed at both ends of the crossbar 1 and being capably of adjusting a distance, and a shell 2 wrapping the clamping device. The clamping device includes a bracket 3, a clamping mechanism 4 installed on the bracket 3, and a locking mechanism 5.

The clamping mechanism 4 includes a first clamping plate 41, a second clamping plate 42 and a spare third clamping plate 43 that are installed below the bracket 3. The first clamping plate 41 is provided with multiple gear slots 44 with different heights for the second clamping plate 42 or the third clamping plate 43 being inserted. A Fastener 45 for connecting the first clamping plate 41 and the second clamping plate 42 or connecting the first clamping plate 41 and the third clamping plate 43 is provided between the first clamping plate 41 and the second clamping plate 42 or between first clamping plate 41 and the third clamping plate 43.

The locking mechanism 5 includes a first locking member 51 slidably installed on the crossbar 1, a second locking member installed on the bracket 3, and a pushing member 53 that is rotatably installed on the bracket 3 and drives first locking member 51 to move backward and forward. The first locking member 51 and the second locking member 51 are slide-fit with each other in an inclined surface and are cooperated to clamp the crossbar 1. The first clamping member 51 and the second clamping member 52 have a first motion that the first clamping member 51 and the second clamping member 52 clamp the crossbar 1 and a second motion that they release the crossbar 1 when the pushing member 53 drives the first locking member 51 to move forward and backward. This technical solution provides a clamping device at both ends of the crossbar 1, which can be applied to a car with a side rail on the roof. A distance between both ends of the clamping mechanisms 4 of the crossbar 1 is firstly determined through the locking mechanism 5, and then a clamping force of the clamping mechanism 4 is adjusted through the fastener to firmly clamp the side rail on both side by the clamping mechanism 4.

In addition, when the pushing member in the locking mechanism drives the first locking block to move towards a center of the crossbar, the first locking member and second locking member release the clamping force on the crossbar, allowing the clamping device to adjust its position on the crossbar. After adjusting the position and the pushing member driving the first locking block to move towards an end of the crossbar, the first locking member and second locking member increase the clamping force on the crossbar until it is locked.

This technical solution also involves providing with a spare third clamping plate that can be used in turn with the second clamping plate to render the roof luggage bracket correspond to different sizes of side rails on both sides of the roof. When selecting the second clamping plate, the second clamping plate is installed on the first clamping plate in an insertion manner. The gear slots on the first clamping plate are divided into multiple gears in an upper and a lower location, and an installation height of the second clamping plate can be adjusted in different positions. The first clamping plate and the second clamping plate are then fixed and connected through the fastener, and an installation manner of the third clamping plate and second clamping plates is the same. This technical solution has advantages of good universality, simple structure, convenient installation, convenient adjustment, and high working reliability.

A strip hole 46 is provided on the second clamping plate 42 and the third clamping plate 43 for installing the fastener 45. When the second clamping plate 42 is adjusted in an upper or a lower position, the fastener 45 can slide in the strip hole, which has advantages of convenient adjustment and good practicality.

A gasket 47 is respectively provided between the second clamping plate 42 and the fastener 45 and between third clamping plate 43 and the fastener 45, and a side surface where the gasket 47 contacts with the fastener 45 is a planar surface and the other side surface where the gasket 47 contacts with the fastener 45 is a spherical surface. As shown in FIG. 8, when a width of the side rail is too large, it will inevitably cause the second clamping plate 42 to tilt when installing the fastener 45. With the use of the gasket with a spherical surface, even if the second clamping plate 42 tilts, the fastener 45 can play a role of firmly fixing. The fastener 45 is a bolt.

A lower end of the second clamping plate 42 is provided with a second clamping member 48, and the second clamping member 48 is provided with a bend towards the first clamping plate 41.

A lower end of the third clamping plate 43 is provided with a third clamping member 49, and the third clamping member 49 is provided with two bends towards the first clamping plate 41, and a height dimension of the second clamping member 48 is greater than that of the third clamping member 49. The shown second clamping plate and third clamping plate correspond to side rails with different sizes and shapes, respectively, and render this roof luggage bracket of the present disclosure be suitable for most conventional side rails of roof.

A cross-sectional area of the first locking member 51 is in a shape of character “ [symbol] ” and a respective groove 54 is provided on both sides of the first locking member 51 to accommodate the second locking member, a lower bottom surface of the groove 54 and a lower bottom surface of the second locking member is a respective slide-fit slope, and an upper surface of the groove 54 and an upper end of the second locking member cooperate together to clamp the crossbar 1, one end of the pushing member 53 is rotatably installed on the bracket 3 and the other end of the pushing member 53 is thread-connection to the first locking member 51; the first locking member 51 and the second locking member have a first motion that they cooperate to clamp the crossbar 1 and a second motion that they release the crossbar 1 when the pushing member 53 drives the first locking member 51 to move backward and forward in a straight line. As shown in FIG. 4, a lower part of the first locking member is located inside the bracket, and an upper part thereof is hung in the sliding groove of the crossbar. When the pushing member rotates, a thread at its end will drive the first locking member to move in a straight line within the passing groove of the bracket. The passing groove plays a role of limit and anti-rotation on the first locking member. And as shown in FIG. 4, when the pushing member rotates forward, the first locking member moves away from the pushing member, and a lower bottom surface of the groove of the first locking member detaches from a lower bottom surface of the second locking member. A distance between the second locking member and the crossbar increases, thereby achieving an effect of releasing the crossbar, and at this point, a position of the clamping mechanism can be adjusted to fit the distance between the side rails on both sides.

After adjusting the distance, the pushing member rotates backward and gradually move the first locking member closer to the pushing member. By using an inclined surface to push the first locking member downwards, the distance between the second locking member and the crossbar gradually decreases until the first locking member and second locking member firmly clamp the crossbar. During the above adjustment process, the second locking member is fixedly connected to the bracket, and thus, the bracket is fixed.

The second locking member is consisted of two folded plates 52 symmetrically arranged on both sides of the first locking member 51, the folded plates 52 are in a shape of numeral “7” and fixedly installed on the bracket 3. The installation mode of the folded plate in this embodiment has the following multiple implementation modes:

implementation mode 1: side wall positions of the folded plate are welded and fixed on both side wall positions of the passing groove 31; and

implementation mode 2, the folded plate and bracket are integrally formed.

In the above two implementation modes, an upper surface of the folded plate 52 is exposed above the bracket 3, and the upper surface of the folded plate cooperates with the lower surface of the groove of the first locking member to clamp the crossbar. The upper surface of the bracket can also be used to replace the upper surface of the folded plate, and the upper surface of the bracket cooperates with the lower surface of the groove of the first locking member to clamp the crossbar.

A slop at a lower end of the folded plate 52 gradually increases from front to back, and a slope of a lower surface of the groove 54 of the first locking member 51 gradually decreases from front to back. The first locking member moves away from the pushing member, which can cause the first locking member and folded plate to loosen the crossbar. Conversely, it can cause the first locking member and folded plate to clamp the crossbar.

The pushing member 53 is a bolt and is provided with a bolt head 55 and a limit nut 56 that is fixed installed, the bolt head 55 and limit nut 56 are respectively located on both sides of the bracket 3, and the limit nut can render the pushing member only rotate on the bracket without an axial displacement.

The first clamping plate 41 and the bracket 3 are integrally bent and formed; the bracket 3 is provided with a passing groove 31 for the first locking member to slide.

The limit nut 56 and the pushing member 53 are fixed by welding.

A sliding groove 11 is arranged in a middle of the crossbar 1 along a length direction for the first locking member 51 to slide, and an upper end of the first locking member 51 is hung inside the sliding groove 11; the first locking member can slide within the sliding groove, thereby adjusting the distance between both sides of the clamping mechanism to adapt to the side rails on the roof.

Two ends of the crossbar 1 are provided with an end cover 12 that is inserted-fit with the crossbar 1, the end cover 12 is provided with a snap buckle 13, a lower surface of the crossbar 1 is provided with a positioning groove 14 for installing the snap buckle 13 in an embedded manner. After the end cover is installed at an end of the crossbar, the snap buckle is pressed into the positioning groove to prevent the end cap from detaching.

The sliding groove 11 is provided with a graduated scale 15 that is installed in a slide manner, and an end of the graduated scale is provided with a convex block 16 extending downwards from the sliding groove 11. The graduated scale can cover the sliding groove and play a role of reducing noise. The convex block can be used to push and pull the graduated scale with fingers. The scale in the graduated scale allows an operator to have a clearer understanding of the distance between both sides of the clamping mechanisms.

An upper surface of the crossbar 1 is provided with an installation groove 17 arranged along a length direction, and the installation groove is provided with a rubber strip 18 that is installed in a slide manner and covers the installation groove; the rubber strip can cover the installation groove and reduce noise.

In the description of the present disclosure, it should be noted that terms “center”, “vertical”, “transverse”, “up”, “down”, “front”, “back”, “left”, “right”, “upright”, “horizontal”, “top”, “bottom”, “inside”, “outside”, etc. indicate an orientation or a position relationship based on the orientation or position relationship shown in the drawings, only for the convenience of describing the present disclosure and simplifying the description, rather than indicating or implying that the device or component referred to must have a specific orientation, be constructed and operated in a specific orientation, thus it cannot be understood as a limitation of the present disclosure. In addition, terms “first” and “second” are only used to describe a purpose and cannot be understood as indicating or implying a relative importance.

In the description of the present disclosure, it should be noted that unless otherwise specified and limited, the terms “install”, “connection”, and “connect” should be understood broadly, for example, they can be a fixed connection, a detachable connection, or an integrated connection, a mechanical connection, an electrical connection, a direct connection, or an indirect connection through an intermediate medium, or it can be an internal connection between two components. For skilled person in the art, a specific meaning of the above terms in the present disclosure can be understood in a specific circumstance. In addition, in the description of the present disclosure, unless otherwise specified, the meaning of “multiple” refers to two or more.

Those skilled in the art should be noted that: although the present disclosure has been described according to the above specific embodiments, an inventive idea of the present disclosure is not limited to the present disclosure. Any modification that applies the inventive idea will be included in the protection scope of the present disclosure.

What is claimed is:

1. A roof luggage bracket, comprising a crossbar (1), a clamping device installed at both ends of the crossbar (1) and being capably of adjusting a distance, and a shell (2) wrapping the clamping device, wherein, the clamping device comprises a bracket (3), a clamping mechanism (4) installed on the bracket (3), and a locking mechanism (5);
wherein the clamping mechanism (4) includes a first clamping plate (41), a second clamping plate (42) and a spare third clamping plate (43) that are installed below the bracket (3), the first clamping plate (41) is provided with multiple gear slots (44) with different heights for the second clamping plate (42) or the third clamping plate (43) being inserted, a fastener (45) for connecting the first clamping plate (41) and the second clamping plate (42) or connecting the first clamping plate (41) and the third clamping plate (42) is provided between the first clamping plate (41) and the second clamping plate (42) or between first clamping plate (41) and the third clamping plate (43).

2. The roof luggage bracket according to claim 1, wherein a strip hole (46) is provided on the second clamping plate (42) and third clamping plate (43) for installing the fastener (45).

3. The roof luggage bracket according to claim 2, wherein a gasket (47) is respectively provided between the second clamping plate (42) and the fastener (45) and between third clamping plate (43) and the fastener (45), and a side surface where the gasket (47) contacts with the fastener (45) is a planar surface and the other side surface where the gasket (47) contacts with the fastener (45) is a spherical surface.

4. The roof luggage bracket according to claim 1, wherein a lower end of the second clamping plate (42) is provided with a second clamping member (48), and the second clamping member (48) is provided with a bend towards the first clamping plate (41);
a lower end of the third clamping plate (43) is provided with a third clamping member (49), and the third clamping member (49) is provided with two bends towards the first clamping plate (41), and a height dimension of the second clamping member (48) is greater than that of the third clamping member (49).

5. The roof luggage bracket according to claim 1, wherein the locking mechanism (5) comprises a first locking member (51) slidably installed on the crossbar (1), a second locking member installed on the bracket (3), and a pushing member (53) that is rotatably installed on the bracket (3) and drives the first locking member (51) to move forward and backward, and the first locking member (51) and the second locking member are slide-fit with each other in an inclined surface and are cooperated to clamp the crossbar (1); the first clamping member (51) and the second clamping member have a first motion that the first clamping member (51) and the second clamping member clamp the crossbar (2) and a second motion that they release the crossbar (1) when the pushing member (53) driving the first locking member (51) to move forward and backward.

6. The roof luggage bracket according to claim 5, wherein a cross-sectional area of the first locking member (51) is in a shape of character “ [symbol] ” and a respective groove (54) is provided on both sides of the first locking member (51) to accommodate the second locking member, a lower bottom surface of the groove (54) and a lower bottom surface of the second locking member is a respective slide-fit slope, and an upper surface of the groove (54) and an upper end of the second locking member cooperate together to clamp the crossbar (1), one end of the pushing member (53) is rotatably installed on the bracket (3) and the other end of the pushing member (53) is thread-connection to the first locking member (51); the first locking member (51) and the second locking member have a first motion that they cooperate to clamp the crossbar (1) and a second motion that they release the crossbar (1) when the pushing member (53) driving the first locking member (51) to move backward and forward in a straight line.

7. The roof luggage bracket according to claim 6, wherein, the second locking member is consisted of two folded plates (52) symmetrically arranged on both sides of the first locking member (51), the folded plates (52) are in a shape of numeral “7” and fixedly installed on the bracket (3), and an upper surface of the folded plate (52) is exposed above the bracket (3).

8. The roof luggage bracket according to claim 7, wherein a slop of a lower end of the folded plate (52) gradually increases from front to back, and a slope of a lower surface of the groove (54) of the first locking member (51) gradually decreases from front to back;
the pushing member (53) is a bolt and is provided with a bolt head (55) and a limit nut (56) that is fixed installed, the bolt head (55) and limit nut (56) are respectively located on both sides of the bracket (3).

9. The roof luggage bracket according to claim 8, wherein the first clamping plate (41) and the bracket (3) are integrally bent and formed; the bracket (3) is provided with a passing groove (31) for the first locking member to slide,
the second locking member is welded and fixed on both side walls of the passing groove (31);
wherein the limit nut (56) and the pushing member (53) are fixed by welding.

10. The roof luggage bracket according to claim 5, wherein, a sliding groove (11) is arranged in a middle of the crossbar (1) along a length direction for the first locking member (51) to slide, and an upper end of the first locking member (51) is hung inside the sliding groove (11);
two ends of the crossbar (1) are provided with an end cover (12), the end cover (12) is provided with a snap buckle (13), a lower surface of the crossbar (1) is provided with a positioning groove (14) for installing the snap buckle (13) in an embedded manner;
the sliding groove (11) is provided with a graduated scale (15) that is installed in a slide manner, and an end of the graduated scale is provided with a convex block (16) extending downwards from the sliding groove (11);
an upper surface of the crossbar (1) is provided with an installation groove (17) arranged along a length direction, and the installation groove is provided with a rubber strip (18) that is installed in a slide manner and covers the installation groove.
